(19) United States
(12) Patent Application Publication
(10) Pub. No.: US 2010/0012877 A1
(43) Pub. Date: Jan. 21, 2010

(54) CLOSURE DEVICE FOR A PRESSURE RESERVOIR OF A GAS-REFRIGERATION GENERATOR, WHICH CAN BE FILLED WITH A COMPRESSED GAS

(76) Inventors: Martin Haege, Boennigheim (DE); Helmut Grantz, Sindelfingen (DE); Gunnar Helms, Renningen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/448,996

(22) PCT Filed: Jan. 9, 2008
(86) PCT No.: PCT/EP2008/000096

§ 371 Date: Jul. 17, 2009

(30) Foreign Application Priority Data
Jan. 17, 2007 (DE) 10 2007 003 321.6

(51) Int. Cl. F16K 15/00

(52) U.S. Cl. 251/318

(57) ABSTRACT

The invention relates to a closure device for a pressure reservoir (14) of a gas-refrigeration generator (11), which pressure reservoir can be filled with a compressed gas. The valve body (21) is arranged so as to be displaceable inside a valve box (18). The valve body (21) has an effective compressive surface facing the main chamber (15) and an effective compressive surface facing the prechamber (52), both surfaces having identical size and being impingeable with the filling pressure of the main chamber (15). The valve body (21) is retained in a closed position by an outer effective compressive surface (64) which is subject to an atmospheric pressure in the direction of closure and by an energy storing element (47).

The invention relates to a closure device for a pressurized-gas inflatable pressure container of a cold gas generator according to the characterizing portion of Claim 1.

A closure device for a pressurized-gas inflatable pressure container of a cold gas generator is known from U.S. Pat. No. 6,068,288. Such cold gas generators are used in particular for vehicle air bag systems. The closure device comprises a valve body which when in a rest position closes a container opening communicating with the ambient air. For the outflow of pressurized gas, an electromagnetic driving apparatus is provided by means of which the valve body may be transferred into a driving position. The valve body is realised in the form of a slide. By a translational movement different flow paths may be released in order to enable the outflow of the pressurized gas. This device has the disadvantage that great forces are required for activating the slide. In addition, these great forces make it more difficult to activate the slide. With a closure device of this type, it is not possible to realise the required short opening times.

Therefore, it is an object of the invention to provide a closure device for a pressurized-gas inflatable pressure container of a cold gas generator that enables an opening movement of a cold gas generator which is both rapid and capable of being activated with great precision, so that a rapid and well-proportioned release of pressurized gas under high pressure as well as a reliable closure after the release of the pressurized gas is made possible.

This object is achieved, according to the invention, by the characteristics of the first claim. Other advantageous configurations and developments are mentioned in the other claims.

According to the invention, the closure device has a valve body slidably arranged within a valve box and moveable within a prechamber of said valve box, the valve body having an effective pressure surface directed towards the main chamber and an effective pressure surface directed towards the prechamber which are equal in size, or approximately equal in size, said valve body further having an outer effective pressure surface upon which an atmospheric pressure is applied in an opening direction as well as another outer effective pressure surface upon which an atmospheric pressure is applied in a closing direction, an energy storing member acting in a closing direction being additionally in engagement with the valve body. In order to achieve a self-locking closing position of the valve body, the outer pressure surface, exposed to an atmospheric pressure acting in the opening direction, is therefore designed to be such that the opening pressure is inferior to the closing pressure resulting from the outer pressure surface exposed to an atmospheric pressure acting in the closing direction and from the closing force of the energy storing member. A configuration of this type makes it possible to achieve a direct activation of the opening and closing movements of the valve body for the outflow of pressurized gas. In addition, this assembly has the advantage of providing a floating mounting of the valve body within the valve box, in which an effective pressure surface directed towards the main chamber is equal in size, or approximately equal in size, to an effective pressure surface directed towards the prechamber, so that an equilibrium of forces, or something next to an equilibrium of forces, is realised and the high internal container pressure may be considered to be almost neutralized, as far as the forces acting upon the valve body within the prechamber are concerned. As a result, the closing force of the valve body is reduced to the compressive force resulting from the atmospheric pressure upon the pressure surfaces acting in the opening and closing directions and from the closing force of the energy storing member. Thus, considerably reduced forces, as compared to the actual internal container pressure, are sufficient to activate an opening movement. Thus it is possible to obtain a rapid and precise activation both in an opening direction and in a closing direction. This permits very short work cycles, making it possible to generate not only a single outflow but repeated outflows of the pressurized gas from the filled pressure container. This configuration according to the invention has additionally the advantage that pressure tolerances due to changing working temperatures will have no influence on the activation and on the response times of the closure device. The reason for this is that the filling pressure of the pressure container is also present in the prechamber of the valve box and that the respective, effective pressure surfaces are equal in size, or approximately equal in size, such that a pressure balance will occur regardless of the absolute pressure present in the pressure container.

According to an advantageous configuration of the invention, the first effective pressure surface on the valve body, which is directed towards the main chamber, is designed to be limited by a seal, in particular a seat seal, and the second effective pressure surface on the valve body, which is directed towards the prechamber, is designed to be limited by a seal, in particular a seat seal, a diameter of an inner circumference of the seal on the first effective pressure surface, directed towards the main chamber, being equal to a diameter of an outer circumference of the seal on the other effective pressure surface of the valve body, which is directed towards the prechamber. Thus it is possible to ensure a design that permits, in an easy manner, to determine the exact dimensions of the pressure surfaces to be provided on the valve body and directed both to the main chamber and to the prechamber, such that the desired closing force is determined in a precise manner and substantially by atmospheric pressure.

In a preferred configuration of the invention, the valve body is designed to be realised as a valve body having at least two parts, forming the first and second effective pressure surfaces. Thus the geometrical requirements for the configuration of the effective pressure surfaces may be met in an easy manner.

Between the at least two parts making up the valve body, a seal is provided which is realised in the form of a permanently tight seal. Thus it is possible to tightly seal one or several interfaces of the valve body, consisting of two or several parts, relative to the environment, so that no filling pressure may escape.

Preferably, the valve box is equally realised in two parts. This allows a simple assembly, together with the valve body. Preferably, the interface of the two-part valve box is sealed by a permanent seal. By analogy, this is also true of a valve box consisting of several parts. Thus, a reliable sealing of the prechamber of the valve box may be ensured.

Furthermore, the valve body is designed to have one or several through holes extending in the sliding direction and forming a connection between the main chamber and the prechamber, a preferred configuration providing one big, central through hole. One big, central through hole represents in particular a simple design configuration for forming a two-part valve body and for enabling a rapid compensation of pressure levels between the main chamber and the prechamber.

According to another preferred embodiment of the invention, the entrance and/or exit of the central through hole in the valve body is designed to be provided with a rounded or trumpet-like profile. Thus it is possible to obtain advantageous flow conditions which contribute, in addition, to minimize friction, so as to eliminate any retardation in the opening and closing movements of the valve body.

Furthermore, the valve body is preferably designed to have a reduced diameter portion which is in engagement with a radially inward-facing, annular collar of the valve box. This makes it possible to provide the effective pressure surface on the valve body directed towards the prechamber with a relatively large size and to adapt it to the effective pressure surface directed towards the main chamber, such that a large container opening of the pressure container may be realised. In addition, this undercut may receive an energy storing member acting in a closing direction which is supported, on one side, on the radially inward-facing, annular collar of the valve box and abuts, on the opposite side, on a radially outward-facing, annular collar of the valve body.

According to a further, preferred configuration a driving apparatus is designed to be provided adjacent to the prechamber and an armature is designed to be capable of being activated by an actuator. This arrangement makes it possible to realise a structure which is easy to assemble and which has a compact layout.

Preferably, a seal serving to create a permanently tight closure between the prechamber and the environment is designed to be provided between the housing of the driving apparatus and the valve box.

For activating the valve body, the armature is preferably designed to be realised as an annular disk that is, in particular, undetachably fastened to the valve body. This may be realised, for example, by means of a non-positive or positive joint. Furthermore, also material connections such as adhesive-bonded joints, welded joints, or the like, may be provided. Furthermore, a valve body portion may be formed together with the armature as a single piece.

The driving apparatus preferably has a housing including an accommodation space into which the actuator is insertable, a sealing plate being provided in order to seal said actuator accommodation space with respect to the prechamber. This makes it possible to ensure that the actuator is not located in the area of high pressure but is arranged in a space separate from the prechamber.

Furthermore, this sealing plate is preferably designed to form a stop for damping the opening movement of the valve body. This permits to reduce the oscillations created during the opening and closing movements of the valve body.

According to a further, alternative configuration of the invention, a radially outward-facing, annular collar of the valve body which closes the container opening is designed to be provided with a non-sealing damping ring arranged radially on a surface of its outer circumference and which engages with the valve box. This damping ring enables a better guiding and a damping of the oscillatory system.

In order to improve the outflow conditions of the pressurized gas, a rotationally symmetrical guide surface is preferably designed to be arranged in the container opening of the pressure container, said guide surface having a tube portion directed into the interior of the container and provided, at the opposite end, considering the outflow direction, with a flare. This contributes to a deflection of the effluent pressurized gas toward the radially arranged outlets and permits to homogenize the flow field at an early stage. Thus it is possible to achieve better defined flow conditions.

According to a further, preferred configuration of the invention, a rotationally symmetrical guide surface is designed to be provided in a region of the valve body directed towards the main chamber, said guide surface being oriented so as to deflect the effluent pressurized gas. This rotationally symmetrical guide surface has preferably an extension corresponding, by analogy, with that of the rotationally symmetrical guide surface arranged in the container opening of the pressure container so as to smooth the flow field and obtain an advantageous outflow. In addition, this rotationally symmetrical guide surface on the valve body has the advantage that when the guide surface is exposed to the flow, a buoyant force is created for the valve body which counteracts a possible closing force that might occur due to dynamic pressure changes. A rapid opening may thus be boosted. The rotationally symmetrical guide surface is preferably trumpet-like.

According to a further alternative configuration of the invention, a pressure compensation assisting member is designed to be provided on a bottom side of the valve body with a central through hole, said member extending, at least when the valve body is in a closing position, into a region of reduced pressure and/or smoothed flow of the pressure container. This assembly has the advantage that it is possible to obtain a rapid pressure compensation between the main chamber and the prechamber during the outflow of the pressurized gas and that any turbulences occurring in the outflow region have no influence, or only a small influence, on the pressure compensation between the main chamber and the prechamber.

Preferably, the pressure compensation assisting member extending into the interior of the pressure container is designed to have a preferably cylindrical tube portion which is preferably formed with a smaller diameter than that of the fastening portion which is insertable into the diameter of the central through hole. Thus it is possible, on the one hand, to have a simple connection of said tube portion with the valve body and, on the other hand, to reduce the moving mass. In addition, this configuration has the advantage that in the transition zone leading to the valve body the tube portion has an enlargement portion that permits a flow-enhancing deflection. Thus it is achieved that the outer surface of said member again forms a rotationally symmetrical guide surface so as to provide a homogenization of the flow field.

According to another preferred configuration of the invention, said tube portion is designed to have an intermediate portion which adjoins the enlarged portion and is inserted into the central through hole of the valve body. Preferably, a press fit or a material engagement is realised in order to ensure a reliable assembly and reception of the pressure compensation assistant member within the valve body.

According to a further preferred configuration of the invention, the guide surfaces provided in the pressure container which define the flow field of the effluent pressurized gas are designed to have a rough surface. This makes it possible to have a stall right at the guide surfaces, thus enabling a flow profile having a high mass flow rate.

According to a further, preferred configuration of the invention, a driving apparatus is designed to be provided in a region of the valve body directed towards the container opening of the pressure container, said driving apparatus being capable of being activated for activating, in turn, a closing movement of the valve body. Thus it is possible to have a separate and adjusted activation of the valve body for an opening and a closing movement.

This driving apparatus preferably has a control space in which a closing body or a control element, in particular a sleeve, is inserted. This additional control element may accelerate the closing movement of the valve body in that the control element substantially closes the outflow cross-section and in that the compressive forces acting in the opening direction are considerably reduced by the effluent pressurized gas. The control element is designed to first be activated by the driving apparatus in order to reduce the effective compressive force. Subsequently, a rapid closing of the valve body is achieved.

Preferably, this control element is designed to be realised in the form of a sleeve provided within a control space of the valve body adjacent to a container opening of the pressure container, said sleeve being movable along a longitudinal axis of the valve body. This permits to reduce the opening diameter of the exit opening and thus to achieve a pressure reduction. This changed pressure situation leads to an immediate closing movement of the valve body.

Preferably, the control element is further designed to be arranged in the control space of the valve body with a radial play. This is to permit a simple and rapid activation.

The invention, as well as other advantageous embodiments and developments thereof, will be described and explained in the following with reference being made to the examples shown in the drawings. The characteristics issuing from the description and the drawings may be applied according to the present invention either individually or as a plurality of features taken in any combination. In the drawings:

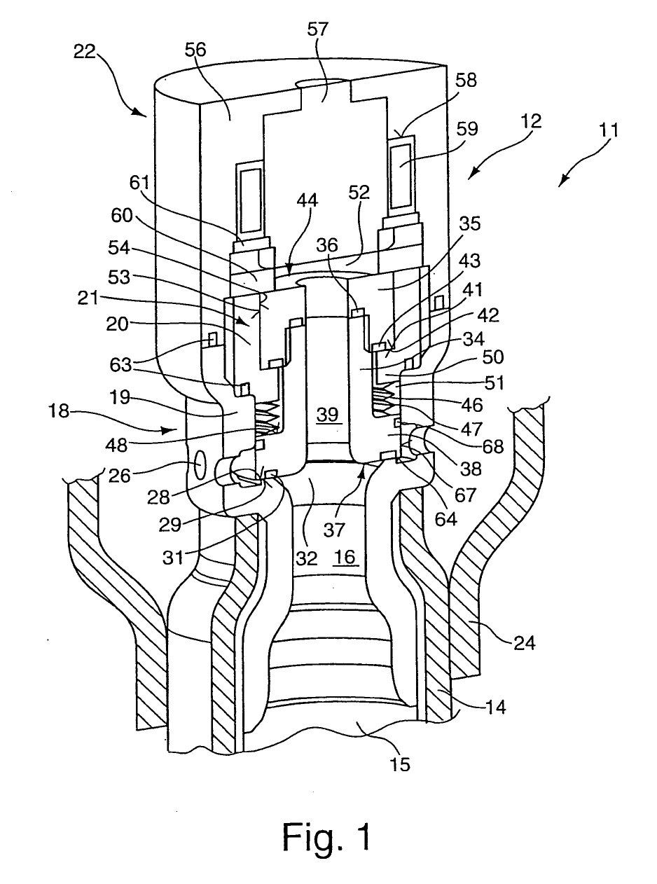

FIG. 1 is a schematic sectional view of a cold gas generator with a first embodiment of the closure device in a closing position;

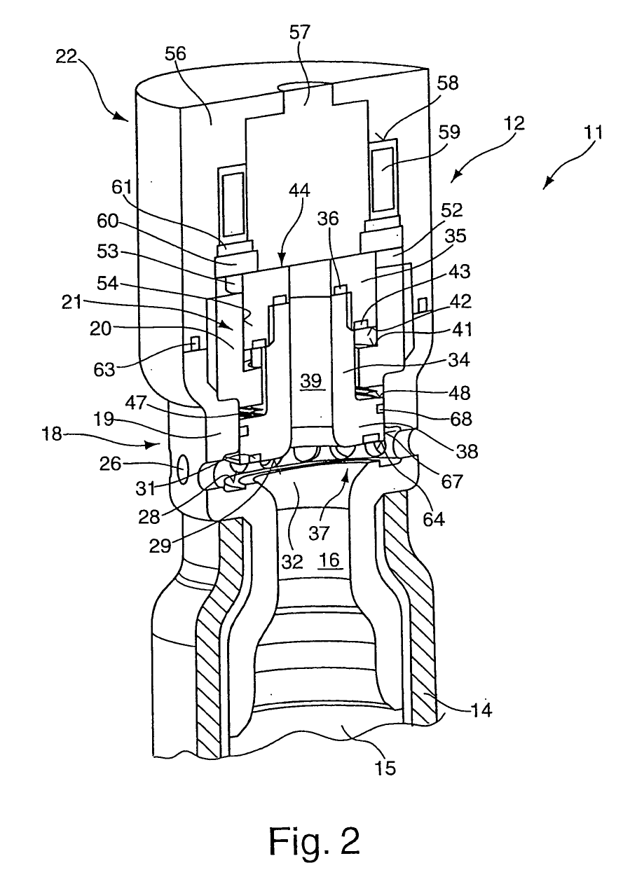

FIG. 2 is a schematic sectional view of the embodiment according to FIG. 1 in a working position;

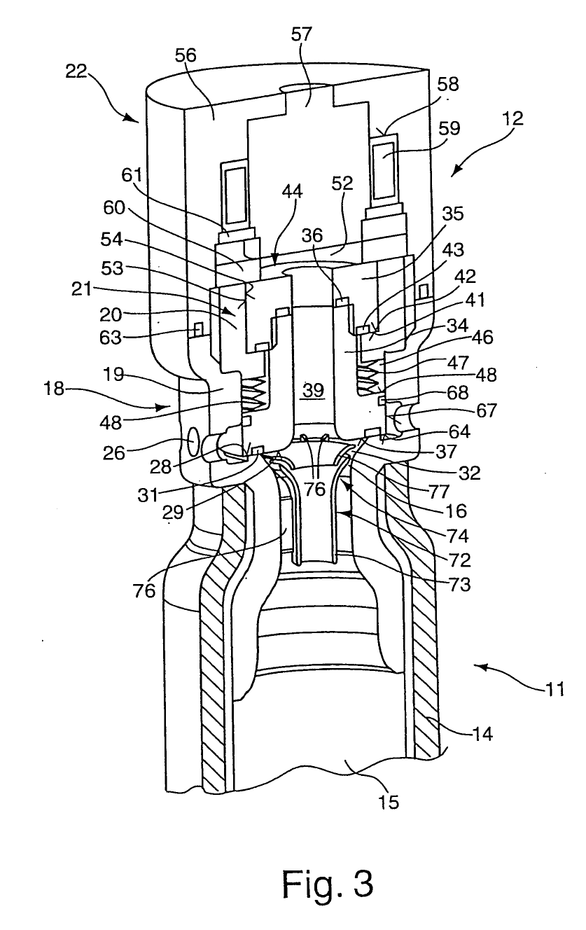

FIG. 3 is a schematic sectional view of a cold gas generator with another embodiment of the closure device in a closing position;

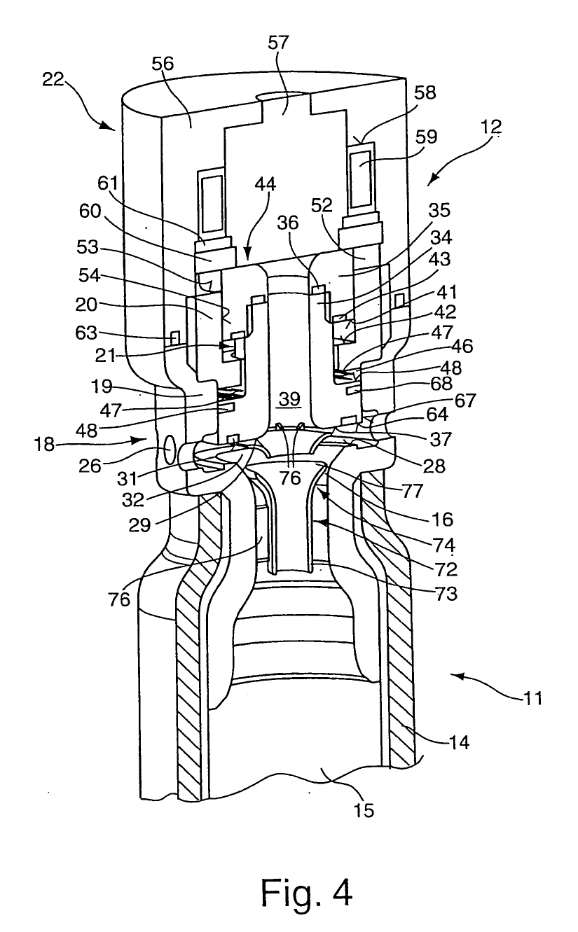

FIG. 4 is a schematic sectional view of the embodiment according to FIG. 3 in a working position;

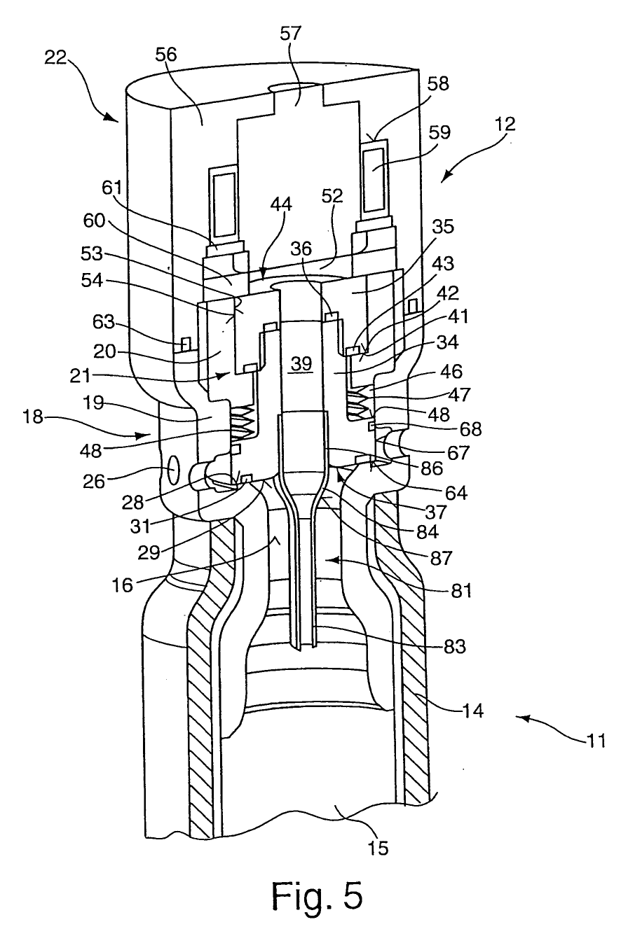

FIG. 5 is a schematic sectional view of an alternative embodiment according to FIG. 3 in a closing position;

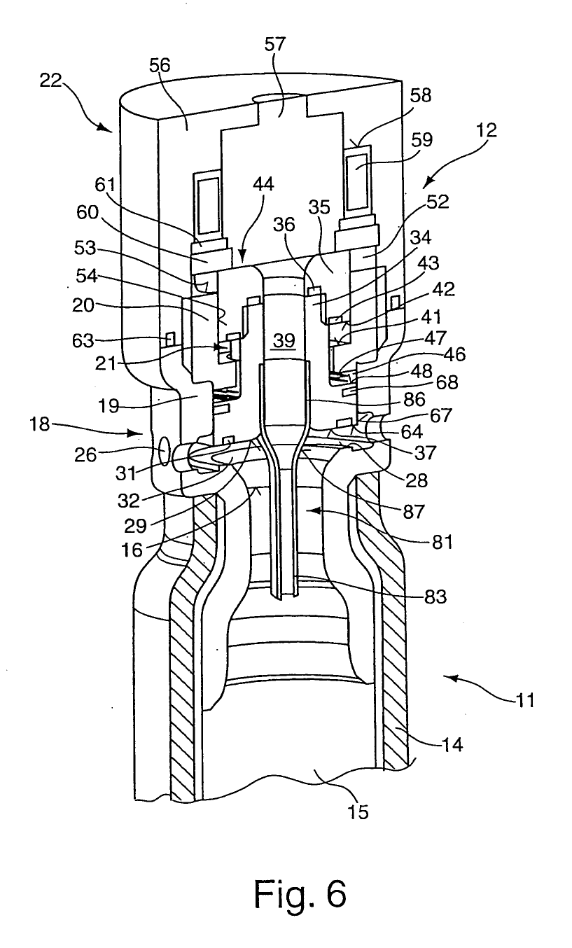

FIG. 6 is a schematic sectional view of the embodiment according to FIG. 5 in a working position;

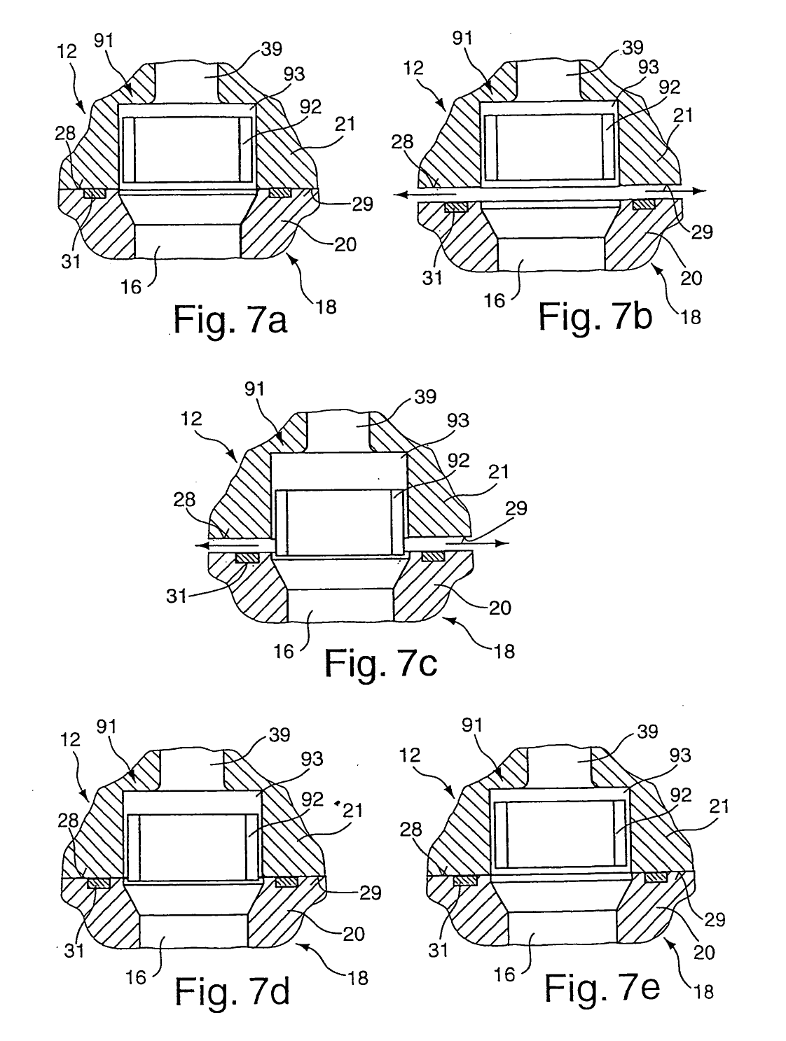

FIGS. 7a to 7e are schematic sectional views of a further alternative embodiment of a closure device according to FIG. 1.

FIG. 1 shows a schematic sectional view of a cold gas generator 11 with a first embodiment of a closure device 12 provided in a pressure container 14. The pressure container 14 has a container opening 16 on the upper end thereof. Said container opening 16 is inserted into a valve box 18 which, according to the embodiment, is formed of two parts. The valve box 18 may also consist of several parts. A lower portion 19 of the valve box 18 engages the container opening 16 and projects into an interior of the pressure container 14, which forms a main chamber 15, and extends in an opposite direction outside the pressure container 14. The valve box 18 houses a valve body 21 and a driving apparatus 22 which, together with the valve box, form the closure device 12.

A pressure bag 24, the beginnings of which are shown in FIG. 1 but which is provided on all pressure containers 14, is affixed to an outer periphery of the pressure container 14. The moment a signal is detected by a control unit, not shown, which triggers the utilisation of a pressure bag 24 the valve body 21 is transferred, by the driving apparatus 22, from a closing position shown in FIG. 1 to a working position or opening position shown in FIG. 2, so that the pressurized gas contained in the pressure container 14 may flow into the pressure bag 24 via the outlets 26 which are radially arranged in the valve box 18.

At a lower portion 19 of the valve box 18 a valve seat 28 is provided whereat valve face 29 of valve body 21 abuts when in a closing position. In said valve face 29, a seal 31 is provided which contacts valve seat 28 and closes an exit zone 32 between the container opening 16 and the outlets 26.

Preferably, the valve body 21 is formed of two parts and has a first valve body portion 34 and a second valve body portion 35 which are attachable relative to each other. Preferably, a threaded joint is provided so as to enable easy assembly. Other alternative embodiments for a permanent, fixed connection between the two valve body portions 34, 35 are also possible. At a point of separation between the first valve body portion 34 and the second valve body portion 35, a seal 36 is preferably provided so as to ensure a durable tightness of said point of separation. The first valve body portion 34 is shaped in the form of a sleeve and is provided with an annular collar 38 directed radially outward and on the axial end face of which, directed towards the container opening 16, the valve face 29 is formed. Due to the sleeve-shaped configuration of the first valve body portion 34, a central through hole 39 is provided which also extends along the second valve body portion 35.

The second valve body portion 35 is equally shaped in the form of a sleeve and has a second valve face 41 directed towards the container opening 16 and abutting on a valve seat 42 of an upper portion 20 of the valve box 18. In this valve face 41 of the valve body 21 a seal 43 is provided which is preferably shaped in the same form as the seal 31. In particular, a seat seal may be provided for this purpose.

Between upper and lower portions 19, 20 of the valve box 18 an undercut or taper 46 is formed in which an energy storing member 47 is arranged. Said energy storing member 47 may be a spiral spring, a disk spring, or the like. Other types of energy storing member may equally be utilised. Towards one side, the energy storing member 47 is in engagement with an outer pressure surface 48 provided on the annular collar 38 of the valve body 21 opposite the valve face 29. At the opposite side, said energy storing member 47 is in engagement with an annular surface 51 of a radially inward-facing, annular collar 50 formed on the upper portion 20 of the valve box 18.

The valve body 21 is slidably guided within a prechamber 52 in the valve box 18, more specifically in the upper portion 20 of the valve box 18. For this purpose, guide surfaces may be provided, for example, between an outer periphery 53 of the valve body portion 35 and an inner periphery 54 of the upper portion 20. The lifting movement of the valve body 21 is limited by the driving apparatus 22 which is in engagement with the upper portion 20 of the valve box 18. The driving apparatus 22 comprises a ferrite core 57 inserted into a housing 56 as well as an actuator 59 arranged within an accommodation space 58. The accommodation space 58 is closed by a sealing plate 61 Said sealing plate 61 preferably extends entirely over the accommodation space 58, such that within the accommodation space 58 no internal container pressure is applied on the actuator 59. The lifting movement of the valve body 21 may be limited by the core 57 or, in particular, by the sealing plate 61. Said sealing plate 61 is preferably also provided with damping properties. The driving apparatus 22 further comprises an annular armature 60 that is permanently connected with the valve body 21. Said armature 60 may additionally be guided by an inboard guide portion along the core 57 and/or the housing 56. The prechamber 52 is permanently sealed by means of a seal 63 located in the transition zone leading from the housing 56 of the driving apparatus 22 to the upper portion 20 of the valve box 18. This seal 63 may also be provided at the upper end of the upper portion 20 of the valve box 18 relative to the housing 56 of the driving apparatus 22.

The configuration described above achieves a closure device 12 with a floating valve body 21 in which the pressure within the main chamber 15, i.e. within the pressure container 14, is equal to that existing in the prechamber 52. Due to the large central through hole 39 such pressure compensation is rapidly achieved and pressure balance may be maintained. The closing force applied on the valve body 21 is independent, or nearly independent, of the internal container pressure, due to the pressure balance and to the configuration of the effective pressure surfaces 37, 44. For this purpose, the first effective pressure surface 37, acting on the valve face 29 of the valve body 21, is designed to be determined by the inner diameter of the seal 31. The second effective pressure surface 44, facing towards the prechamber 52, is determined by an outer diameter of the seal 43. In order to enable a floating mounting, the inner diameter of the seal 31 corresponds, or substantially corresponds, to the outer diameter of the seal 43, such that a pressure balance may occur. As a result, the closing force is determined by the atmospheric pressure acting from outside and by the force of the energy storing member 47. Via the outlets 26, atmospheric pressure is applied to the outer pressure surface 48, acting in a closing direction, in which also the energy storing member 47 acts. The resulting compressive force is determined by the size of the outer pressure surface 48 and by the force of the energy storing member 47. This closing force is opposed by an opening force acting via an outer pressure surface 64 formed on the annular collar 38 outside the seal 31. To ensure the predominance of a closing force, it is thus necessary that the compressive force of the energy storing member 47 combined with the compressive force resulting from the outer pressure surface 48 exceed the compressive force, acting in the opposite direction, which results from the outer pressure surface 64 on the annular collar 38.

To activate the valve body 21, an electromagnetic driving apparatus 22 is supplied with electrical current, thus achieving a lifting movement of the valve body 21 and a separation of the valve face 29 of the valve body 21 from the valve seat 28 on the valve box 18. Thus, the pressurized gas may flow into the pressure bag 24 via the outlets 26. During the outflow of the pressurized gas, again a pressure compensation between the prechamber 52 and the main chamber 15, or the interior of the pressure container 14, takes place, such that the floating mounting of the valve body 21 and the equilibrium of forces acting thereon may be maintained because of the through hole 39. To close the valve body 21, the driving apparatus 22 is stopped, such that the closing force generated by the energy storing member 47 and the outer pressure surface 48 transfers the valve body 21 into a closing position, as shown in FIG. 1.

For a better guiding of the valve body 21 within the valve box 18, a damping ring 68 may preferably be provided on a radial outside circumference 67 of the annular collar 38. Such a damping ring 68 may also contribute to the damping of the oscillatory system. This damping ring 68 has no sealing function.

The present embodiment thus has the advantage that the valve body 21 is capable of being activated in a direct manner, which makes it possible to achieve short response times and an improved controllability. In addition, this assembly has the advantage, due to the wide cross-sections of flow, that it is possible to use nitrogen for the pressurized gas, which makes it possible to have less severe requirements concerning the specifications for the tightness of the system than would be necessary with the use of helium. This closure device 12 is formed as an independent unit and may be mounted to the respective pressure container 14, the lower portion 20 of the valve box 18 being modified in order to be affixed to the container opening 16. Furthermore, such a closure device 12 is tolerant towards changing temperature and pressure conditions.

FIG. 3 is an alternative embodiment of a closure device 12, differing from FIG. 1, and represented in a closing position. FIG. 4 shows alternative embodiments according to FIG. 3 in a working position. In the following, reference will be made to FIGS. 1 and 2, owing to the correspondences in the respective features.

The embodiment according to FIGS. 3 and 4 differs from the embodiment of FIG. 1 in that a rotationally symmetrical guide surface 72 is provided within the container opening 18 which has a tube portion 73 projecting into the interior of the container and a tube portion 74 directed in the opening direction and having a flared end. Due to this guide surface, which is preferably shaped in the form of a funnel or, in particular, a trumpet, and which is retained relative to the lower portion 20 of the valve box 18 by means of lands 76, the flow field during the outflow of the pressurized gas is homogenized at an early stage and the outflow velocity is increased. Preferably, at a bottom side of the valve body another rotationally symmetrical guide surface 77 is provided which is equally retained relative to the bottom side of the valve body 21 by means of lands 76. This rotationally symmetrical guide surface 77 partially engages with the rotationally symmetrical guide surface 72 when the valve body 21 is in a closed position. This permits to achieve that in an opened condition of the closure device 12 the volumetric flow passing through the tubular portion 73 of the rotationally symmetrical guide surface 72 is equally deflected in the direction of the outlet 26 via the guide surface 77. At the same time, the opening speed of the valve body 21 is increased, due to the applied compressive force. In a working position, the flared tube portion 74 of the rotationally symmetrical guide surface 72 and the rotationally symmetrical guide surface 77 form a fan-like assembly for flow deflection.

Rotationally symmetrical guide surfaces 72, 77 of this type may, even retrofittably, be inserted into a container opening 16 or mounted on a bottom side of the valve body 21, either individually or in a combined configuration.

FIG. 5 represents an alternative embodiment of the closure device 12 according to FIG. 1 in a closing position. FIG. 6 shows the embodiment according to FIG. 5 in a working position. Considering the corresponding features, reference will be made to the figure description relating to FIGS. 1 and 2.

In this embodiment, the valve body 21 has a pressure compensation assisting member 81 accommodated on its bottom side and directed towards the pressure container 14. This pressure compensation assisting member 81 is shaped in the form of a tube and has, for example, a first cylindrical tube portion 83 which extends through the container opening 16 and into a region of reduced pressure and/or smoothed flow of the pressure container 14. This cylindrical tube portion 83 is adjoined, in the outflow direction of the pressurized gas, by an enlargement portion 84 which graduates into a fastening portion 86. This fastening portion 86 is preferably cylindrical and is designed to be pressed into the through hole 39 of the valve body 21. Alternatively, other types of connection, by non-positive, positive, or material engagement, for fastening the pressure compensation assisting member 81 to the valve body 21 may be provided. The enlargement portion 84 preferably has an outer surface 87 which, as to its geometry, roughly resembles, or corresponds to, a flared tube portion 74 of the rotationally symmetrical guide surface 72 or to the rotationally symmetrical guide surface 77, in order to achieve a flow deflection. This pressure compensation assisting member 81, which may also be referred to as a trunk, enables a rapid pressure compensation in the prechamber 52 with respect to the main chamber 15, as soon as pressurized gas flows out from the pressure container 14 and pressure conditions in the prechamber 52 change due to an opening or a closing movement of the valve body 21. This has the particular advantage that a closing force acting upon the closing valve body 21 may be counteracted, since during the outflow of the pressurized gas a negative pressure is created in the outflow region 32.

In the aforementioned embodiment it is generally advantageous that the surfaces exposed to the flow be rough surfaces, such that a boundary layer thickness of a flow profile will become thinner, as said boundary layer is better controllable with turbulent flows than with laminar flows.

FIGS. 7a to 7e represent a further alternative embodiment of a closure device 12 according to FIG. 1 with only the portion of the part of the valve body 21 directed towards the container opening 16 which differs from FIG. 1 being represented on an enlarged scale. For the rest, full reference is made to the description relating to the embodiment according to FIG. 1.

In a lower portion of the valve body 21 a driving apparatus 91 is provided. Due to this supplemental driving apparatus 91 working in addition to the driving apparatus 22, the force situation for the opening process, on the one hand, and for the closing process, on the other, may be optimised. Said driving apparatus 91 comprises a control element, in particular a sleeve 92, within a control space 93 that forms a part of the through hole 39. The control space 93 and the sleeve 92 are dimensioned such that the diameter of the through hole 39 extends fully over the length of the valve body 21. Outside the control space 93 an actuator, not shown, is provided which causes an adjustment movement of the sleeve 92. The sleeve 92 is movably lodged within the control space 93 and has sufficient radial play. The function and operation of the driving apparatus 91 will be described in the following, with reference being made to FIGS. 7a to 7e. FIG. 7a represents the closing position of the valve body 21 relative to the container opening 16. The valve face 29 abuts on the valve seat 28.

By activating the driving apparatus 22, the valve body 21 is transferred to a working position. During this working stroke, the sleeve 92 remains within the control space 93. The exit zone 32 for the outflow of the pressurized gas is unblocked.

In order to rapidly transfer the valve body 21 into a closing position, the driving apparatus 91 is actuated. By activating the sleeve 92, the latter is moved out of the control space 93 by a lifting movement so that it is moved into the exit zone 32, thus enabling a primary blocking of the radial outlets 26, as is represented in FIG. 7c. Due to the changed pressure situation, an abrupt transfer of the valve body 21 into a closing position occurs, as is represented in FIG. 7d. Subsequently, the sleeve 92 is completely retracted into the control space 93, as is represented in FIG. 7e, in order to ensure that a new opening movement of the valve body 21 will not be inhibited. The retracting of the sleeve 92 into the control space 93 may be achieved, for example, by means of a spring. An alternative embodiment of this type may also be combined with the embodiments according to FIGS. 3 to 6.

1. A closure device for a pressurized-gas inflatable pressure container of a cold gas generator, said pressure container comprising a container opening whereon the closure device for forming a cold gas generator may be arranged,
said device having a valve body which, when in a closing position, closes at least one outlet communicating with the environment and which, with the aid of a driving apparatus for opening the at least one outlet, may be transferred to a working position,
said device having a valve box within which the valve body is slidably arranged and communicates with a prechamber in the valve box and with a main chamber formed by a pressurized area of the pressure container,
said valve body has having an effective pressure surface directed towards the main chamber and an effective pressure surface directed towards the prechamber, which are equal in size, or approximately equal in size, and may be exposed to the filling pressure of the main chamber, characterized in that
the valve body has an outer effective pressure surface, upon which an atmospheric pressure acts in the opening direction, and another outer effective pressure surface, upon which said atmospheric pressure acts in the closing direction and with which an energy storing member is in engagement, and
the compressive force acting in the opening direction and resulting from the outer effective pressure surface exposed to atmospheric pressure is inferior to the closing force acting in the closing direction and resulting from the outer effective pressure surface exposed to atmospheric pressure and from the force of the energy storing member.

2. The closure device of claim 1, characterized in that the first effective pressure surface on the valve body, which is directed towards the main chamber, is limited by a seal, in particular a seat seal, and the second effective pressure surface on the valve body, which is directed towards the prechamber, is limited by a seal, in particular a seat seal, an inner diameter of the seal on the first effective pressure surface, directed towards the main chamber, being equal to an outer diameter of the seal on the other effective pressure surface, which is directed towards the prechamber.

3. The closure device of claim 1 or 2, characterized in that for forming the first and other effective pressure surfaces a valve body having at least two parts is formed.

4. The closure device of claim 3, characterized in that between the at least two parts forming the valve body a seal is provided which ensures permanent tightness.

5. The closure device of claim 1, characterized in that the valve box is formed of at least two parts and preferably comprises a lower portion and an upper portion.

6. The closure device of claim 5, characterized in that between the at least two parts forming the valve box a seal is provided which ensures permanent tightness.

7. The closure device of claim 1, characterized in that the valve body has one or several through holes extending in the sliding direction of the valve body and forming a connection between the main chamber and the prechamber, a preferred configuration providing one big, central through hole.

8. The closure device of claim 1, characterized in that the entrance and/or exit of the central through hole is provided with a funnel-shaped or trumpet-like profile.

9. The closure device of claim 1 characterized in that the valve body has a reduced diameter portion which is in engagement with a radially inward-facing, annular collar of the valve box.

10. The closure device of claim 9, characterized in that in the reduced diameter portion the energy storing member is arranged which engages with an annular surface of the inward-facing, annular collar of the valve box and, at the opposite side, abuts on an outer pressure surface provided on a radially outward-facing, annular collar of the valve body.

11. The closure device of claim 1, characterized in that adjacent to the prechamber the driving apparatus is provided, having an accommodation space for an actuator which drives an armature.

12. The closure device of claim 11, characterized in that said armature is shaped in the form of an annular disk.

13. The closure device of claim 11 or 12, characterized in that said armature is undetachably fastened to the valve body.

14. The closure device of claim 11, characterized in that the accommodation space in the housing of the driving apparatus is pressure-sealed by a sealing plate.

15. The closure device of claim 14, characterized in that the sealing plate is formed as a stop for damping the opening movement of the valve body.

16. The closure device of claim 11, characterized in that a housing of the driving apparatus is detachably fastened to the valve box, a seal being preferably provided at a point of separation.

17. The closure device of claim 1, characterized in that a radial, annular collar of the valve body which closes the container opening is provided with a non-sealing damping ring arranged radially on a surface of its outer circumference and which is in engagement with an inner circumference of the valve box.

18. The closure device of claim 1, characterized in that a rotationally symmetrical guide surface is arranged in the container opening of the pressure container which has a tube portion that is directed into the main chamber and graduates at the opposite end, considering the outflow direction of the pressurized gas, into a flared tube portion.

19. The closure device of claim 18, characterized in that the rotationally symmetrical guide surface is positioned coaxially to the longitudinal axis of the container opening by means of lands.

20. The closure device of claim 1, characterized in that a rotationally symmetrical guide surface is provided in a region of the valve body directed towards the main chamber, said guide surface being formed so as to deflect the effluent pressurized gas in the direction of the outlets.

21. The closure device of claim 20, characterized in that the rotationally symmetrical guide surface has a funnel-shaped or trumpet-like geometry, with the small opening cross-section of the rotationally symmetrical guide surface directed towards the container opening and the large opening cross-section directed towards the valve body.

22. The closure device of claim 20, characterized in that the rotationally symmetrical guide surface is retained on the valve body coaxially to the longitudinal axis of the valve body by means of lands.

23. The closure device of claim 1, characterized in that a pressure compensation assisting member is provided on a bottom side of the valve body, which has a central through hole, said member extending, at least when the valve body is in a closing position, into a region of reduced pressure and/or smoothed flow of the pressure container.

24. The closure device of claim 23, characterized in that the pressure compensation assisting member has a preferably cylindrical tube portion which extends into the main chamber and has a fastening portion inserted into, or engaging with, a central through hole of the valve body.

25. The closure device of claim 23, characterized in that an enlargement portion is provided between the tube portion and the fastening portion of the pressure compensation assisting member.

26. The closure device of claim 23, characterized in that a outer surface of the enlargement portion has a trumpet-like or funnel-shaped guide surface for flow deflection.

27. The closure device of claim 23, characterized in that the fastening portion of the pressure compensation assisting member is inserted into, in particular pressed into, the through hole of the valve body.

28. The closure device of claim 1, characterized in that the flow-forming surfaces provided in the pressure container, the valve box and the valve body are rough surfaces.

29. The closure device of claim 1, characterized in that a driving apparatus is provided in a region of the valve body directed towards the container opening of the pressure container, said driving apparatus being capable of being activated for activating, in turn, a closing movement of the valve body.

30. The closure device of claim 13, characterized in that the driving apparatus at the bottom side of the valve body comprises a control space within which a control element, in particular a sleeve, is accommodated so as to be movable in the opening and closing directions of the valve body.

31. The closure device of claim 29, characterized in that the control element, in particular the sleeve, is capable of being activated in such a way, when the valve body is in a working position, that the latter partially closes an exit zone between the container opening and the outlets.

32. The closure device of claim 30, characterized in that the control element, in particular the sleeve of the driving apparatus, is arranged in the control space of the valve body with a radial play.
